(19) United States
(12) Patent Application Publication
(10) Pub. No.: US 2015/0016024 A1
(43) Pub. Date: Jan. 15, 2015

(54) CATHODE ACTIVE MATERIAL HAVING CORE-SHELL STRUCTURE AND PRODUCING METHOD THEREOF

(71) Applicant: KOREA INSTITUTE OF SCIENCE AND TECHNOLOGY, Seoul (KR)

(72) Inventors: Won Chang CHOI, Gyeonggi-do (KR); Ji Hun PARK, Seoul (KR); Martin HALIM, Seoul (KR); Joong Kee LEE, Seoul (KR); Jung Sub KIM, Gyeongsangnam-do (KR); Kyu-Ha LEE, Seoul (KR); Bong Jo KANG, Seoul (KR); A Young KIM, Seoul (KR); Hun Gi JUNG, Busan (KR); Yu Jin CHAE, Daejeon (KR); Joo Man WOO, Seoul (KR); Yong-Ho LEE, Incheon (KR); Tae Yong KIM, Gyeongsangnam-do (KR)

(73) Assignee: KOREA INSITIUTE OF SCIENCE AND TECHNOLOGY, Seoul (KR)

(21) Appl. No.: 14/031,239

(22) Filed: Sep. 19, 2013

(30) Foreign Application Priority Data
Jul. 12, 2013 (KR) 10-2013-0082347

(51) Int. Cl. H01G 11/50; H01G 11/62; H01G 11/86; H01G 11/04

(52) U.S. Cl. CPC H01G 11/50; H01G 11/04; H01G 11/62; H01G 11/86
USPC 361/505; 361/516; 361/508; 427/80

(57) ABSTRACT

Disclosed is a cathode active material having a core-shell structure. The core-shell cathode active material includes a core including a lithium transition metal oxide with excellent electrochemical properties and a shell formed by coating the surface of the core with a transition metal oxide. The formation of the shell by coating a transition metal oxide on the surface of the core comprising a lithium transition metal oxide prevents the structure of the lithium transition metal oxide from collapsing and inhibits the dissolution of manganese ions, enabling the fabrication of a hybrid capacitor with improved energy density and rate characteristics. Also disclosed is a method for producing the cathode active material.

### CROSS-REFERENCE TO RELATED APPLICATIONS

This application claims priority under 35 U.S.C. §119 to Korean Patent Application No. 10-2013-0082347 filed on Jul. 12, 2013 in the Korean Intellectual Property Office, the disclosure of which is incorporated herein by reference in its entirety.

### BACKGROUND OF THE INVENTION

1. Field of the Invention

The present invention relates to a cathode active material having a core-shell structure. More specifically, the present invention relates to a core-shell cathode active material including a core including a lithium transition metal oxide with excellent electrochemical properties and a shell formed by coating the surface of the core with a transition metal oxide, and a method for producing the cathode active material.

2. Description of the Related Art

Since the first commercial lithium secondary battery was developed by Sony, Japan, in 1991, lithium secondary batteries have been used as representative energy storage devices with high energy density. With recent advances in electronics, communications, and computer industries, lithium secondary batteries have received attention as important power sources for driving portable electronic information communication devices. Such lithium secondary batteries employ composite metal oxides, such as LiCoO₂, LiMn₂O₄, LiNiO₂, and LiNi₁₋ₓCoₓO₂ (0<x<1) as cathode active materials.

Among the above-described cathode active materials, LiCoO₂ was first commercialized due to its long electrode life and high high-rate discharge capacity. However. LiCoO₂ is disadvantageously expensive. LiNiO₂, a nickel-based cathode active material, exhibits excellent battery characteristics, such as the highest discharge capacity, but tends to suffer from rapid degradation of life and be susceptible to high temperature. In contrast, LiMn₂O₄ is simpler to synthesize, inexpensive and environmentally friendly. However, Mn has an average oxidation number of 3.5, local Jahn-Teller distortion for Mn³⁺ ions during charge/discharge leads to collapse of the structure of the lithium manganese oxide, and manganese ions are dissolved by reaction with an electrolyte, resulting in a reduction in electrode life. These disadvantages of the cathode active material constitute obstacles to the commercialization of lithium secondary batteries.

On the other hand, electric double layer capacitors have been introduced as alternative energy storage devices. Electric double layer capacitors can accumulate electric energy based on the phenomenon that electric charges are accumulated in an electric double layer created at the interface between a solid electrode and an electrolyte. In comparison with lithium secondary batteries, electric double layer capacitors have low energy density but have the advantages of very short charge time, relatively high output density, and long cycle life. Due to these advantages, electric double layer capacitors have attracted increasing attention in various application fields.

Carbon materials such as active carbon are widely used as anode and cathode active materials of conventional capacitors. The capacitance of a capacitor is obtained by electrostatic adsorption of dissociated cations and anions to the active carbon surfaces of an anode and a cathode, respectively. Such an electric double layer capacitor has rapid charge/discharge characteristics and semi-permanent cycle life due to its low internal resistance when charged/discharged but is rather unsatisfactory in terms of energy density.

In attempts to overcome the disadvantages of electric double layer capacitors and lithium secondary batteries, hybrid capacitors including a cathode using a lithium transition metal oxide in place of active carbon are currently being developed. For example, Korean Patent Application No. 10-2006-0075743 discloses a hybrid capacitor including a cathode similar to that of a lithium secondary battery and an anode similar to that of an electric double layer capacitor. The cathode uses a cathode active material for a lithium secondary battery.

The hybrid capacitor consisting of a cathode using a lithium transition metal oxide and an anode for an electric double layer capacitor has improved capacity compared to a conventional electric double layer capacitor. However, a voltage impulse is applied to the anode composed of active carbon in the hybrid capacitor because of asymmetric outputs between the cathode and the anode. This limits the use of the hybrid capacitor at high output and high voltage.

In order to solve these problems, Korean Patent Publication No. 10-2005-0069736 discloses a cathode for a hybrid supercapacitor that uses a cathode active material including a powder of a lithium transition metal oxide and active carbon. However, the above-mentioned problems remain unsolved.

### SUMMARY OF THE INVENTION

The present invention has been made in view of the above problems, and it is an object of the present invention to provide a core-shell cathode active material in which a lithium transition metal oxide is coated with a transition metal oxide to prevent the structure of the lithium transition metal oxide from collapsing and to inhibit the dissolution of manganese ions, achieving improved energy density and rate characteristics.

It is another object of the present invention to provide a method for producing the cathode active material at low cost in a short processing time through a simple and easy process.

A still another object of the present invention is to provide a hybrid capacitor that uses the cathode active material, achieving excellent output and cycle characteristics.

According to an aspect of the present invention, there is provided a core-shell cathode active material including a core including a lithium transition metal oxide and a shell formed by coating the surface of the core with a transition metal oxide.

The lithium transition metal oxide is selected from the group consisting of LiCoO. LiMn₂O₄, LiMnO₂, LiNiO₂, LiNi₁₋ₓCoₓO₂ (0<X<1). Li—Ni—Mn-based composite oxides, and Li—Ni—Mn—Co-based composite oxides.

The transition metal oxide is represented by Formula 1:

MOₓ (1)

wherein M represents a transition metal and is selected from the group consisting of Mn, Ru, Co, Ni, and Fe, O represents oxygen, and x represents the number of oxygen atoms bonded to the transition metal M.

The transition metal oxide is present in an amount of 1 to 30% by weight, based on the weight of the lithium transition metal oxide.

According to a further aspect of the present invention, there is provided a method for producing the core-shell cathode active material, including

i) mixing a transition metal oxide precursor with a lithium transition metal oxide core in a solution,

ii) allowing the mixed solution to react in an inert or reducing atmosphere to obtain a coprecipitate or a composite, and

iii) collecting the coprecipitate or the composite by filtration, followed by drying.

The transition metal oxide precursor is a solution of a metal alkoxide, an organic solution of a metal salt, or an aqueous solution of a metal.

The metal may be selected from the group consisting of Mn, Ru, Co, Ni, and Fe.

The lithium transition metal oxide is selected from the group consisting of LiCoO₂, LiMn₂O₄, LiMnO₂, LiNiO₂, LiNi₁₋ₓCoₓO₂ (0<X<1), Li—Ni—Mn-based composite oxides, and Li—Ni—Mn—Co-based composite oxides.

The reducing agent is hydrazine or polyethylene glycol.

In step ii), the reaction time is from 1 to 5 hours.

According to another aspect of the present invention, there is provided a hybrid capacitor including a cathode including the core-shell cathode active material, an anode including an anode active material, a separator, and an electrolyte including a lithium salt.

The cathode further includes a binder. The binder may be selected from the group consisting of polyimide, polyethylene, polypropylene, polyvinyl alcohol, polyvinyl chloride, styrene-butadiene rubbers, cellulose-based polymers, nitrile-based polymers, and fluorinated polymers.

The cathode further includes a conductive material. The conductive material may be conductive carbon, a conductive metal, or a conductive polymer.

The lithium salt may be selected from the group consisting of LiPF₆, LiBF₄, LiClO₄, Li(CF₃SO₂)₂, LiCF₃SO₃, LiSbF₆, and LiAsF₆.

The anode active material includes active carbon, graphite-based carbon, or lithium ion-intercalated graphite-based carbon.

In the cathode active material of the present invention, the lithium transition metal oxide is coated with the transition metal oxide. This coating prevents the structure of the lithium transition metal oxide from collapsing and inhibits the dissolution of manganese ions, enabling the fabrication of a hybrid capacitor with improved energy density and rate characteristics.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 shows cross-sectional scanning electron microscopy (SEM) images of (a) a transition metal oxide used in Comparative Example 1, (b) a lithium transition metal oxide core used in Comparative Example 1, and (c) a core-shell cathode active material produced by coating a transition metal oxide on the surface of a lithium transition metal oxide core in Example 1;

FIG. 2 shows (a) a transmission electron microscopy (TEM) image and (b) energy dispersive X-ray spectra (EDS) of the cross-section of a cathode active material produced in Example 1; and

FIG. 3 shows charge/discharge voltage profiles of (a) a hybrid capacitor fabricated in Example 1 and (b) a hybrid capacitor fabricated in Comparative Example 1.

### DETAILED DESCRIPTION OF THE INVENTION

The present invention will now be described in detail with reference to the accompanying drawings.

The present invention provides a cathode active material for a hybrid capacitor. Specifically, the cathode active material of the present invention has a core-shell structure in which the core includes a lithium transition metal oxide and the shell is formed by coating the surface of the core with a transition metal oxide.

The lithium transition metal oxide is a cathode active material for a lithium secondary battery and the transition metal oxide is a cathode active material for a pseudo-capacitor. Therefore, the surface coating of the lithium transition metal oxide with the transition metal oxide can solve the disadvantages of the two energy storage devices, enabling the fabrication of a hybrid capacitor with improved energy density and rate characteristics.

The lithium transition metal oxide may be selected from the group consisting of LiCoO₂, LiMn₂O₄, LiMnO₂, LiNiO₂, LiNi₁₋ₓCoₓO₂ (0<X<1), Li—Ni—Mn-based composite oxides, and Li—Ni—Mn—Co-based composite oxides, which are cathode active materials for lithium secondary batteries commonly used in the art. A lithium manganese oxide is preferred.

The transition metal oxide coated on the surface of the core is a cathode active material for a pseudo-capacitor and may be represented by MOx wherein M is a transition metal selected from the group consisting of Mn, Ru, Co, Ni, and Fe, O is oxygen, and x represents the number of oxygen atoms bonded to the transition metal M.

The content of the transition metal oxide is from 1 to 30% by weight, based on the weight of the core-forming lithium transition metal oxide. If the content of the transition metal oxide is less than 1% by weight, the role of the transition metal oxide as a protective film to inhibit the dissolution of manganese from the core may not be sufficient, resulting in a reaction of the manganese with an electrolyte and an insufficient increase in capacity. Meanwhile, if the content of the transition metal oxide exceeds 30% by weight, the shell becomes thick, posing a risk that the characteristics of the lithium transition metal oxide may deteriorate.

The present invention also provides a method for producing the cathode active material. Specifically, the method of the present invention is based on a co-precipitation process and includes i) mixing a transition metal oxide precursor with a lithium transition metal oxide core in a solution, ii) allowing the mixed solution to react in an inert or reducing atmosphere to obtain a coprecipitate or a composite, and iii) collecting the coprecipitate or the composite by filtration, followed by drying. According to the method of the present invention, the production procedure is simplified and the production cost is reduced.

First, the lithium transition metal oxide core is mixed with water or an organic solvent. The mixture is stirred for 0.5 to 2 hours, and then a transition metal oxide precursor is added thereto.

The transition metal oxide precursor may be a solution of a metal alkoxide, an organic solution of a metal salt, or an aqueous solution of a metal. Preferably, the transition metal oxide precursor includes a metal element selected from the group consisting of Mn, Ru, Co, Ni, and Fe.

Next, the mixed solution is allowed to react with stirring in an inert or reducing atmosphere for 1 to 5 hours. As a result of the reaction, a coprecipitate or a composite can be obtained.

The content of the transition metal oxide to be coated is determined by controlling the amount of the transition metal oxide precursor mixed rather than by controlling the synthesis time.

The reaction is carried out in the presence of a proper reducing agent or under a flow of an inert gas. A sufficient stirring force is usually needed to form dense particles, but air may be incorporated into the mixed solution during stirring to partially oxidize labile manganese ions, making the product less dense. In the method of the present invention. an inert gas atmosphere is created or a reducing agent is added to inhibit the oxidation of manganese ions. The reducing agent is not specially limited but is preferably hydrazine or polyethylene glycol.

Finally, the coprecipitate or the composite is collected by filtration and dried to obtain the core-shell cathode active material in the form of a powder.

The present invention also provides a hybrid capacitor including a cathode including the core-shell cathode active material, an anode including an anode active material, a separator, and an electrolyte including a lithium salt.

The cathode may further include a binder. The binder may be selected from the group consisting of polyimide, polyethylene, polypropylene, polyvinyl alcohol, polyvinyl chloride, styrene-butadiene rubbers, cellulose-based polymers, nitrile-based polymers, and fluorinated polymers.

The cathode may further include a conductive material. The conductive material may be conductive carbon, a conductive metal, or a conductive polymer. The lithium salt may be selected from the group consisting of LiPF₆, LiBF₄, LiClO₄, Li(CF₃SO₂)₂, LiCF₃SO₃, LiSbF₆, and LiAsF₆.

The anode active material may be a compound capable of reversible intercalation and deintercalation of lithium. Specific examples of suitable anode active materials include carbonaceous materials, such as artificial graphite, natural graphite, graphitized carbon fiber and amorphous carbon, and lithium ion-intercalated graphite-based carbon. These anode active materials may also be used in any combination so long as the effects of the present invention are not impaired.

The following examples of the present invention will be specifically explained with reference to the accompanying drawings.

### EXAMPLE 1

### (1) Production of Core-Shell Cathode Active Material

Commercial LiMn₂O₄ was sufficiently stirred in distilled water for 1 h, and then KMnO₄ as a MnO₂ precursor was added thereto with stirring. The mixture was allowed to react for 3 h while dropwise adding ethylene glycol as a reducing agent, affording a core-shell cathode active material.

The KMnO₄ was added in an amount such that the content of MnO₂ reached 10 wt % with respect to the weight of the LiMn₂O₄. A color change of the mixed solution was observed to determine whether black MnO₂ (s) was synthesized from the purple KMnO₄ on the LiMn₂O₄ surface.

### (2) Cathode Production

The core-shell cathode active material, Denka Black (DB) as a conductive material, and polyvinylidene fluoride (PVdF) as a binder were mixed in a weight ratio of 92:4:4. The mixture was dispersed in NMP as a dispersion medium. A slurry was obtained from the dispersion using an agate mortar and pestle set. The slurry was applied to an aluminum foil and dried at 80° C. for 8 h to form a cathode active material layer, completing the production of a cathode for a hybrid capacitor. The cathode was used as a working electrode, a lithium metal foil was used as a counter electrode, electrolyte-wetted polypropylene as a separator, and a 1.31 M solution of LiPF₆ in a mixture of ethylene carbonate, ethyl methyl carbonate, and dimethyl carbonate in a 1:1:1 by volume ratio was used as an electrolyte to fabricate a half cell.

### COMPARATIVE EXAMPLE 1

A half cell was fabricated in the same manner as in Example 1, except that either MnO₂, a cathode active material for a pseudo-capacitor, or LiMn₂O₄, a cathode active material for a lithium secondary battery, was used.

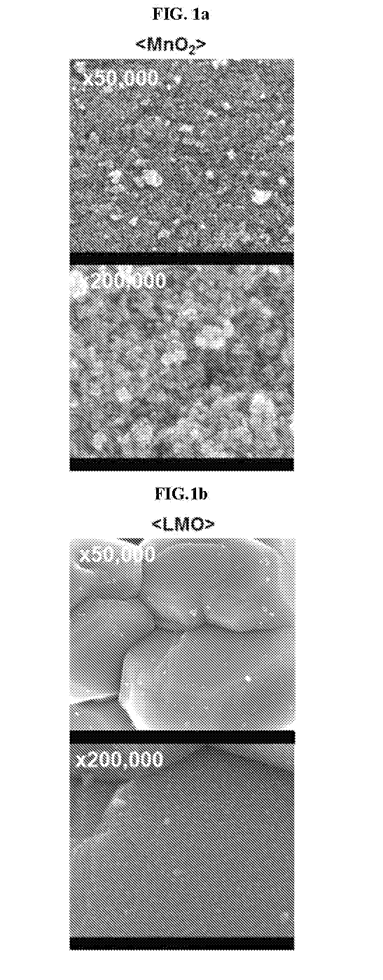

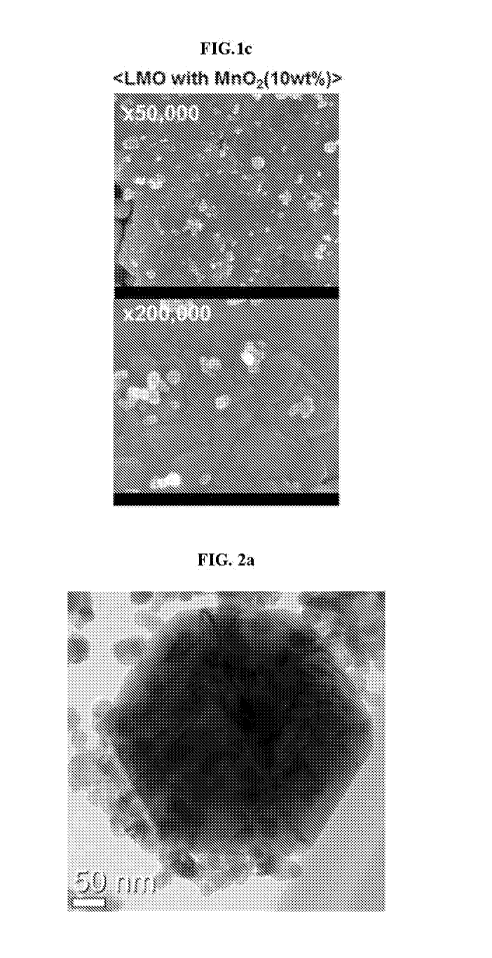

FIG. 1(a) shows cross-sectional scanning electron microscopy (SEM) images of the transition metal oxide used in Comparative Example 1, FIG. 1(b) shows cross-sectional SEM images of the lithium transition metal oxide core used in Comparative Example 1, and FIG. 1(c) shows SEM images of the core-shell cathode active material produced by coating the transition metal oxide on the surface of the lithium transition metal oxide core in Example 1.

FIG. 1(c) confirms that fine MnO₂ particles were coated on the surface of the LiMn₂O₄ particles forming the core of the cathode active material.

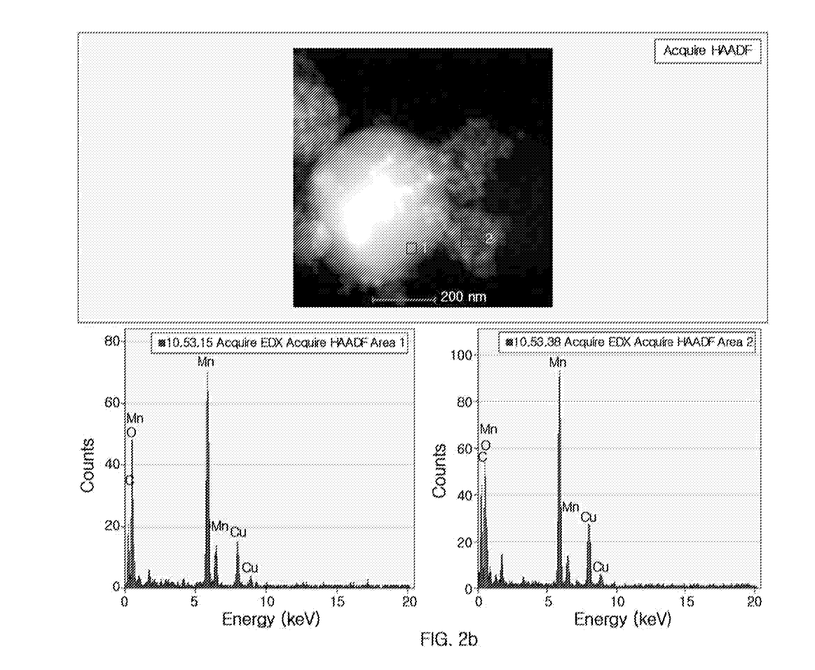

FIG. 2 shows a transmission electron microscopy (TEM) image and energy dispersive X-ray spectra (EDS) of the cross-section of the cathode active material produced in Example 1. As shown in FIG. 2a, the cathode active material produced in Example 1 had a core-shell structure in which a coating layer was formed on the surface of the spherical LiMn₂O₄ particles. FIG. 2b confirms that the coating layer was composed of the transition metal oxide MnO₂.

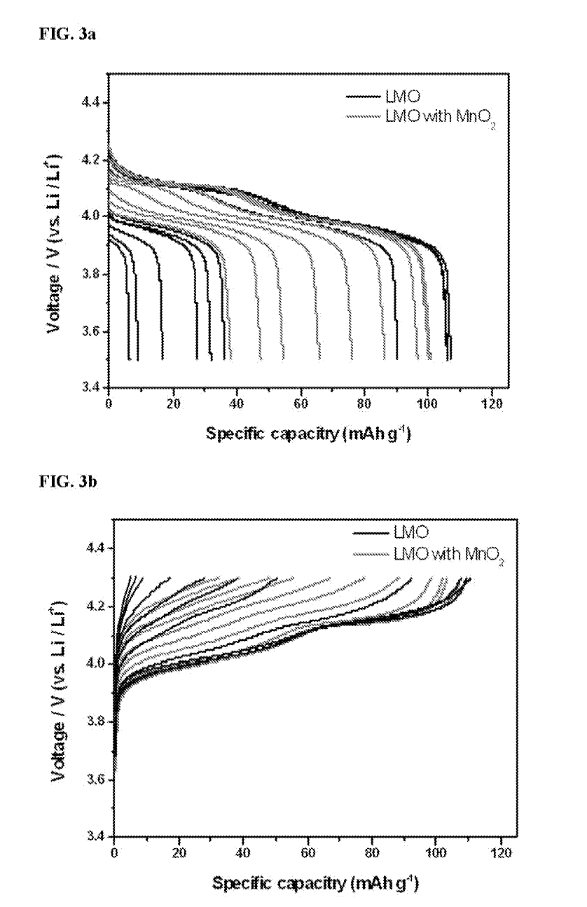

FIG. 3 shows charge/discharge voltage profiles of the hybrid capacitors fabricated in Example 1 and Comparative Example 1. Charge tests were conducted on the capacitors with the hybrid electrodes in the range of 3.5-4.3 V while varying charge C rates at a discharge C rate set to D/10. The charge test results demonstrate that the hybrid capacitor fabricated in Example 1 had excellent rate characteristics.

These results are believed to be because the charge/discharge times were shortened by the coating of the transition metal oxide, a cathode active material for a capacitor, on the surface of the lithium transition metal oxide.

What is claimed is:

1. A core-shell cathode active material comprising a core comprising a lithium transition metal oxide and a shell formed by coating the surface of the core with a transition metal oxide.

2. The core-shell cathode active material according to claim 1, wherein the lithium transition metal oxide is selected from the group consisting of LiCoO₂, LiMn₂O₄, LiMnO₂, LiNiO₂, LiNi₁₋ₓCoₓO₂ (0<X<1), Li—Ni—Mn-based composite oxides, and Li—Ni—Mn—Co-based composite oxides.

3. The core-shell cathode active material according to claim 1, wherein the transition metal oxide is represented by Formula 1:
MOₓ (1)
wherein M represents at least one transition metal selected from the group consisting of Mn, Ru, Co, Ni, and Fe, O represents oxygen, and x represents the number of oxygen atoms bonded to the transition metal M.

4. The core-shell cathode active material according to claim 1, wherein the transition metal oxide is present in an amount of 1 to 30% by weight, based on the weight of the lithium transition metal oxide.

5. A method for producing a core-shell cathode active material, comprising
i) mixing a transition metal oxide precursor with a lithium transition metal oxide core in a solution,
ii) allowing the mixed solution to react in an inert or reducing atmosphere to obtain a coprecipitate or a composite, and
iii) collecting the coprecipitate or the composite by filtration, followed by drying.

6. The method according to claim 5, wherein the transition metal oxide precursor is a solution of a metal alkoxide, an organic solution of a metal salt, or an aqueous solution of a metal.

7. The method according to claim 6, wherein the metal is selected from the group consisting of Mn, Ru, Co, Ni, and Fe.

8. The method according to claim 5, wherein the lithium transition metal oxide is selected from the group consisting of LiCoO₂, LiMn₂O₄, LiMnO₂, LiNiO₂, LiNi₁₋ₓCoₓO₂ (0<X<1), Li—Ni—Mn-based composite oxides, and Li—Ni—Mn—Co-based composite oxides.

9. The method according to claim 5, wherein the reducing agent is hydrazine or polyethylene glycol.

10. The method according to claim 5, wherein, in step ii), the reaction time is from 1 to 5 hours.

11. A hybrid capacitor comprising:
a cathode comprising the core-shell cathode active material according to claim 1;
an anode comprising an anode active material;
a separator; and
an electrolyte comprising a lithium salt.

12. The hybrid capacitor according to claim 11, wherein the cathode further comprises a binder.

13. The hybrid capacitor according to claim 12, wherein the binder is selected from the group consisting of polyimide, polyethylene, polypropylene, polyvinyl alcohol, polyvinyl chloride, styrene-butadiene rubbers, cellulose-based polymers, nitrile-based polymers, and fluorinated polymers.

14. The hybrid capacitor according to claim 11, wherein the cathode further comprises a conductive material.

15. The hybrid capacitor according to claim 14, wherein the conductive material is conductive carbon, a conductive metal, or a conductive polymer.

16. The hybrid capacitor according to claim 11, wherein the lithium salt is selected from the group consisting of LiPF₆, LiBF₄, LiClO₄, Li(CF₃SO₂)₂, LiCF₃SO₃, LiSbF₆, and LiAsF₆.

17. The hybrid capacitor according to claim 11, wherein the anode active material comprises active carbon, graphite-based carbon, or lithium ion-intercalated graphite-based carbon.
